(19) United States
(12) Patent Application Publication
(10) Pub. No.: US 2005/0027666 A1
(43) Pub. Date: Feb. 3, 2005

(54) Interactive online research system and method

(75) Inventors: Robert S. Beck JR., Bellevue, NE (US); Stephanie M. Healy, Omaha, NE (US)

Correspondence Address: GREER, BURNS & CRAIN, 300 S WACKER DR, 25TH FLOOR, CHICAGO, IL, 60606, US

(73) Assignee: Vente, Inc

(21) Appl. No.: 10/619,938

(22) Filed: Jul. 15, 2003

(51) Int. Cl. G06F 17/30

(52) U.S. Cl. 707/1

(57) ABSTRACT

A system and method of locating an online site or document for a user. At least one question is provided to a user, the question being associated with a plurality of predefined answers. One of the plurality of predefined answers is received. This predefined answer is associated with a keyword. A link is retrieved for the online site or document, the link being associated with the keyword.

### FIELD OF THE INVENTION

The present invention relates generally to the field of online information retrieval. The present invention also relates to the fields of advertising and online communication.

### BACKGROUND OF THE INVENTION

With the advancement and continued use of large, online networks, such as the Internet, as a viable medium to manage information, market research has become popular given that research respondents can determine when and how they provide information online, versus an in-person or telephone process. Intrinsic benefits of the Internet, for example, include convenience and empowerment to retrieve and submit online information. With these benefits, however, comes a need for systems and services that direct users to information and information providers, and bring such providers to users.

A search engine may be employed as one example of a conventional system to retrieve information. In a typical search engine, which is typically displayed to a user within a browser program as a World Wide Web (“Web”) page, which may or may not be part of a portal, one or more specific search terms are entered by the user in a blank dialogue box, for example, and submitted via the Internet to one or more servers, having databases containing fields including names or, more typically, uniform resource locators (“URL's”) or IP addresses of Web sites. One or more links to the Web sites having the URL's are displayed on a Web page and the user can select one of the links to be redirected to a page, or to save the link, for example. Once at the page, the user can retrieve or submit information, conduct transactions, etc.

To generate a database employed by a typical search engine, two prominent methods of Web site retrievals are used. In one method, automated programs, for example “spiders”, search the Internet or specific areas, such as the Web, for documents (typically, Web pages) having one or more search terms (also referred to as “keywords”) present in its code, such as within a markup language. Based on the presence of search terms, the search engine ranks the retrieved documents by number of particular terms found, location of the terms within the document, weight of certain terms, etc. Links to these retrieved documents are then stored within a database for comparison with search terms in a particular user query. Preferably, the database is continuously updated. Instead of or in addition to automated searching and retrieval of such documents, links may be discovered, reviewed, and stored manually.

In a second method, which is often used in combination with the first method, particular search terms or keywords are reserved, for example purchased, by individuals such as sponsors. These reserved keywords are associated with particular links in the database, for example, so that entry of these keywords by a user in a search query generates a specific link, such as a link to a sponsor's Web site. If multiple keywords are reserved with different sponsors, an order of provided links may be generated in various suitable ways (prominence or order of keywords entered, sponsor ranking, order in which the words were paid for, etc.). A particular search engine may generate multiple lists of links for a user in response to entry of keywords. For example, a list of sponsored sites may be prominently displayed on a search engine Web page (e.g., at the top of the page) in response to a query, while a list of generated sites may be listed in a particular order in a less prominent portion of a page (e.g., at the bottom of the page). This second method provides sponsors with a way to generate “click-through” traffic to their Web sites, and provides remuneration for an operator of a search engine (a search site, for example), while aiding a user's search for targeted, specific information.

For reserved listings that are sponsored, the keywords forming a query are often purchased by dynamic auction. For example, a particular keyword or combination of keywords may be continuously up for auction among a number of sponsors, who bid on that particular keyword. This authorization process for particular keywords is provided through a “keyword auction provider” (e.g., an automated bidding service), which may supply data to the database. If a particular keyword or combination within a user's query exactly matches that reserved by a sponsor, that sponsor's link is retrieved from the search engine database and is presented to the user. Conventionally, the auction determines the order in which the sponsored links are presented to the user. If a limited number of sponsored links are available for a particular search as selected by the search engine, the auction thus also selects the set of sponsored links that are presented.

However, the conventional search engine and reservation (sponsorship) system has a number of drawbacks. For example, a particular query includes a limited number of specific keywords. To generate a link that is presented to the user, the specific keyword or keyword combination chosen by the user must precisely match the search terms associated with that particular link (a so-called “literal search”). Even with the use of Boolean queries or so-called “natural language” searches, specific keywords or combinations generated from parsing these queries must match associated search terms in a search engine database for a link to be shown to the user. Furthermore, the user may not be adept at choosing keywords for a search, and thus the links revealed to the user may not be appropriate for the actual, intended search. The search engine has no way to determine the intent of the user, and thus provided links may vary significantly from the object of the user's search. This is particularly bothersome if keywords are selected that have multiple, or even opposite, connotations. For example, a search for Web sites to aid in quitting smoking may instead generate links to Web pages containing cigarette ads. As a result, users often are unable to retrieve the information desired without significant difficulty, and sponsors are unable to communicate with potentially interested users.

### SUMMARY OF THE INVENTION

The present invention provides an interactive online research system, and a method of locating an online site or document for a user. According to the inventive system and method, at least one question is provided to a user, the question being associated with a plurality of answers. One or more of the pluralities of answers selected by the user is received by the system. This answer has a predefined association with a keyword. A link is retrieved by the system for the online site or document, the link being associated with the keyword.

### BRIEF DESCRIPTION OF THE DRAWINGS

FIG. 1 is a diagram illustrating a network including an interactive online research system according to a preferred embodiment of the invention;

FIG. 2 is a diagram illustrating parts of a preferred interactive online research system;

FIGS. 3A-3B together form a flow diagram illustrating a preferred operation of the interactive online research system;

FIGS. 4A-4B together form a flow diagram illustrating a method of search term mapping between a keyword auction provider and survey data;

FIGS. 5A-5B together form a flow diagram illustrating a method of analysis of user-provided data to determine calculated appeal and calculated value of pages and surveys;

FIGS. 6A-6C together form a process flow diagram showing a process of information flow among an interactive online research system, a user, and a keyword auction provider;

FIGS. 7A-7D together form a flow diagram illustrating an exemplary survey question and answer session, with illustrations of sample survey questions;

FIG. 8 is a sample screen showing an interactive session within a interactive online research portal; and

FIG. 9 is a sample screen showing an interactive session including a displayed sponsor Web site within the interactive online research system.

### DETAILED DESCRIPTION OF THE INVENTION

The present invention provides, among other things, an interactive online research system and method that collects information, such as consumer information (demographic, interest, ailment, life changes, etc.) from a user of the interactive online research system. From this information, the interactive online research system uses keywords associated with the collected information to determine one or more selected online sites (including Web sites) or documents (including Web pages), and provides links to these sites or other online sites or documents and/or links the user to them. The keywords are provided from keyword auction providers or by other keyword generation systems or methods.

The interactive online research system of the present invention preferably generates an interactive Web property such as, but not limited to, an interactive Web page, Web site, or Web portal that is presented to a user (i.e., a person that logs onto or visits the Web property). The “Web property” is any online (including Internet and Web) based system or device (document (including page), site, portal, etc.) or system component, subset, or part, that may be used to present information to and/or receive information from a user. This Web property is used to collect information from the user by delivering survey questions to the user, some of which preferably are at least partly based upon data received from the user, and then provide links for the user to a Web site or document, preferably including sponsored or reserved Web sites. Questions may include a number of preferably predefined answers that have a predefined association with keywords. As used herein, the term “keyword” or “keywords” may also include keyword combinations. The association between the keywords and the online sites or documents preferably is performed using data from a keyword auction provider, which data is supplied to a database of the interactive online research system.

The Web property of the present interactive online research system also may provide sponsors with an opportunity to communicate with the user, either by receiving, displaying, or transmitting data provided by the user, or by enabling a transaction with the user through exchange of information, or by providing a direct link. This providing of information may or may not be presented to the sponsor in real-time. The selection of information to be provided should be entirely at the option of the user. One or more of these or other options may be available depending on, for example, a level or type of sponsorship (e.g., an amount paid, particular selection of services) of a particular sponsor.

The present invention preferably differs from a conventional search engine at least in that it refines the relevance of the keywords chosen for selecting the online site or document according to the collected information that is in response to the one or more questions having predefined answers, thus selecting more appropriate keywords and improving a search for online sites or documents. Through interaction with the Web property, for example, the user may submit data relating to his or her interests, preferably by answering a series of questions, and the interactive online research system may then provide the user with a link or redirect the user to a Web site or document relating to those interests, based upon predefined associations between certain terms and particular keywords, and accordingly Web sites, as arranged with the keyword auction provider and/or an operator of the online research system. From these targeted sites, a user can then delve into finding information, providing information, and/or conducting transactions with the particular sponsor.

Preferred incorporation of qualitative and quantitative methodologies within a set of questions (a survey) provides a user with multiple paths from which keywords can be derived. For example, cascading survey questions may be built upon self-reported information provided by the user. This information may include basic demographic information, such as, but not limited to, location, income range, age, home ownership, education, occupation, and/or gender. This provided information may then be analyzed to discern an interest probability of additional, targeted survey questions.

Presentation of these targeted survey questions may derive, for example, a variety of interests targeted to the user. Each interest or answer provides additional information. This information may also then be used to predict future interest in survey questions. Upon finding a specific interest that has a targeted opportunity to provide a specific link, Web site, or document, the user is presented with that link, site, or document, such as a Web site of a sponsor.

In a preferred embodiment of the inventive system and method, interests, collected as user selections from among predefined answers, are associated (e.g., mapped) within the interactive online research system against frequently updated, sponsored lists of selected search engine keywords, for example, as provided by keyword auction providers. Based on the selected search engine keywords, a limited set of targeted online sites or documents (or associated links) are selected and retrieved by the system for presenting to the user. These lists preferably are related to a finite number of selected sponsors, for example, five highest-paying sponsors, determined using information from the keyword auction provider. Upon selection of an interest by the user where the interactive online research system has a sponsor opportunity, the system (via the Web property) provides the user with links to the sponsor and/or redirects the user to a selected URL associated with the sponsor. A direct link may be provided, for example, by a separate Web page, a pop-up or pop-under, or most preferably, an HTML IFRAME (inline frame) referred hereinafter as a frame, tabbed window, or other window within a displayed page of the Web property.

As a result, users are provided an appropriate experience in finding information, while sponsors yield information-generating, advertising, and/or transactional results from users having a more particular interest in the sponsors than a typical user linking to the sponsor's site from, for example, a conventional search engine. However, the interactive online research system can be used in combination with, or in place of, an external search engine. The interactive online research system of the present invention may provide, for example, a method and system for increased targeting, product marketing, brand awareness, and delivery of information to meet both business (sponsor) and consumer (user) demand.

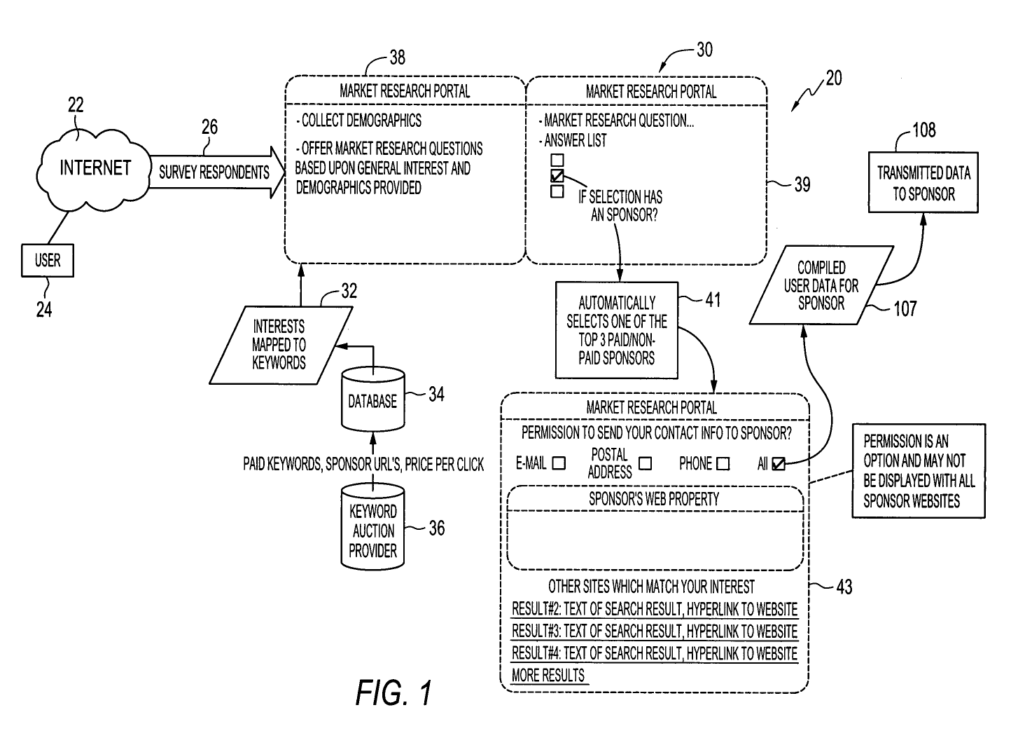

Referring now to the drawings, FIG. 1 shows an overview of operation of an interactive online research system 20, illustrating a preferred system and method of the present invention. It will be apparent to those skilled in the art that the system 20 and method of the present invention may be implemented by use of one or more servers (e.g., clustered servers) and client computers, for example, connected to one another, to a user, to a keyword auction provider, and/or to the Internet, by any suitable online connection mechanism, for example, via a suitably configured network. One or more connected computers configured to perform one or more aspects of the method described herein may embody the invention. The system 20 may also be partially or entirely embodied in a suitable storage medium or via one or more signals provided in a suitable manner, which may be used with one or more suitably configured computers to enable the one or more computers to perform the method of the present invention. The connections illustrated may be logical and/or actual connections.

Generally, via an online network such as the Internet 22, a user 24, using a Web browser or other suitable online interactive program through a client computer or terminal, as non-limiting examples, submits results 26 (e.g., answer selections) of one or more surveys by interacting with a Web property 30 during an interactive session. The Web property 30, generated by a suitably configured software program, is used to present questions to the user 24, retrieve answers, present Web sites or documents to the user, and provide a gateway for interaction between the user 24 and one or more sponsors. As shown in FIG. 1, the Web property 30 may be embodied in a Web portal, but it may instead or additionally be a Web site, or any other suitable interactive online property.

The interactive online research system 20 includes a database 34 (e.g., a server database) for storing, retrieving, and/or analyzing data related to questions and answers, keywords, and collected or reserved Web sites or documents. One or more connected databases may form the database 34, and it is possible that one or more of the databases is not maintained or controlled by the interactive online research system 20. The database 34 preferably includes several components that are used to enhance online market research for a user.

Preferably, each component is frequently updated (for example, varied frequency), and includes a plurality of data points. Some of these data points, signifying connections between sponsors and particular keywords, preferably are provided by a keyword auction provider 36 (“KAP”), such as Overture® or Google®, having access to parts of the database 34. In a preferred embodiment, an import system (not shown) is used to load data from the keyword auction provider 36 into the database 34. Depending on the specific keyword auction provider 36, other interfaces may be included, as will be appreciated by those skilled in the art.

The Web property 30 of the interactive online research system 20 is used to extract information from the results 26, such as, but not limited to, demographic information and interest information, as shown in block 38. For example, the user 24 may respond to a Web page 39 of the Web property 30, having a market research question, by selecting one or more of a list of answer choices. Based on the extracted information, additional questions may be generated and/or retrieved from the database 34, and submitted to the user 24 via the Internet 22.

If a selection made by the user is associated with a keyword that is in turn associated with a sponsor, the system 20 selects a first number of sponsors (block 41) and presents Web pages associated with the sponsor to the user 24. The Web pages may be presented, for example, within a frame of Web page 43 showing and/or listing Web sites or documents, including links to Web sites, as shown by example in FIG. 1.

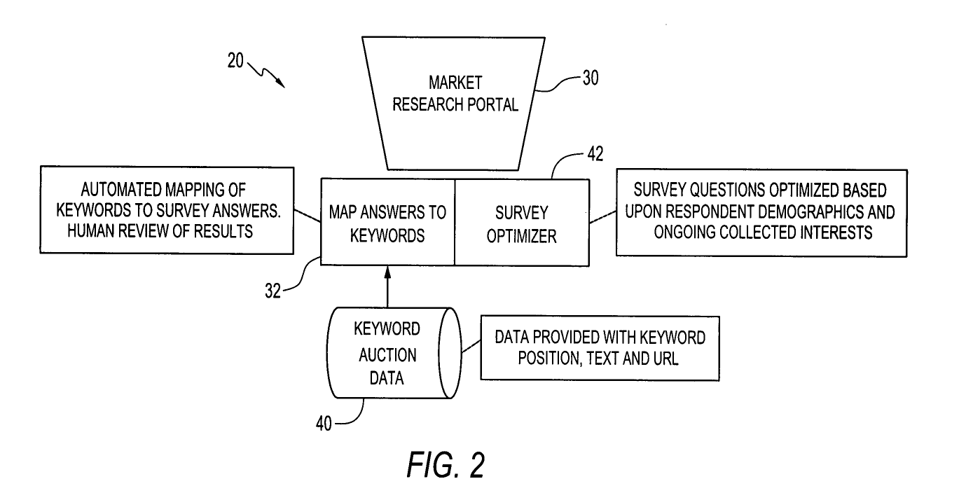

FIG. 2 shows parts of a preferred interactive online research system 20. The interactive online research system 20 preferably includes a mapping system 32 that provides associations between interest or demographic information (as answers to the supplied questions) and certain reserved keywords. Preferably, the mapping system 32 leverages the data from the database 34 supplied by the KAP 36 to redirect users to sponsor Web sites or documents based on targeted keywords.

Keyword auction data 40 (for example, a keyword position, keyword text, and URL) provided by the keyword auction provider 36 and preferably stored within the database 34 is mapped to survey answers by the mapping system 32. The KAP 36 preferably provides a near real-time update to the database 34 of reserved keywords, including data related to a specific keyword's associated pricing (e.g., “cost-per-click” or “CPC”), URL or URL's, and associated text (for example, marketing text that is presented to the user along with the URL) This data is mapped by the mapping system 32 to associate keywords with survey answers, and preferably against the collected results 26, to determine and preferably increase effectiveness of particular survey answers. The mapping system 32 preferably employs both computed and manual data to find an appropriate combination of survey answers to yield an appropriate URL. This mapping process preferably occurs in real-time, or on a periodic (such as daily) basis, to support and optimize the research survey.

For example, in automated mapping, a plausible mapping may be created between answers referenced by answer identifiers, and particular keywords or search words. For each answer identifier, multiple groupings of keywords are preferably sought and retrieved. It is further preferred that the results be reviewed manually within the mapping system 32 to verify and/or optimize them. Within an interface of the mapping system 32, for example, an operator may have the ability to associate specific answer identifiers manually with specific keywords used for a search engine. Preferably, this interface allows the operator to override particular associations to re-associate answers with other keywords, for example, based on an arrangement with a particular sponsor or sponsors of certain keywords.

The Web property 30 preferably is similar in look and feel to a conventional Web site or Web portal, but may be optimized (by inclusion of widgets, for example) to facilitate retrieval of information based on any user supplied demographics or interests. Preferably, the Web property 30 is made to be intuitive for user interaction.

A home page of the Web property 30 may contain, for example, a list of events in the user's life and/or a list of various possible interests of the user 24. The events and/or interests listed in a page of the Web property 30 preferably provide links to one or more survey questions as described above. If multiple selections from the displayed lists are possible, the particular survey questions may be configured to retrieve a variety of answers, which then can be followed up by additional questions to provide more specific questions and answers. The home page (or other pages of the Web property 30) may further contain items that are not related to survey questions, but are found in conventional portal home pages. This provides functionality for the user 24 to make it easier for him or her to use the Web property 30 as a regular entry point for Web browsing or research.

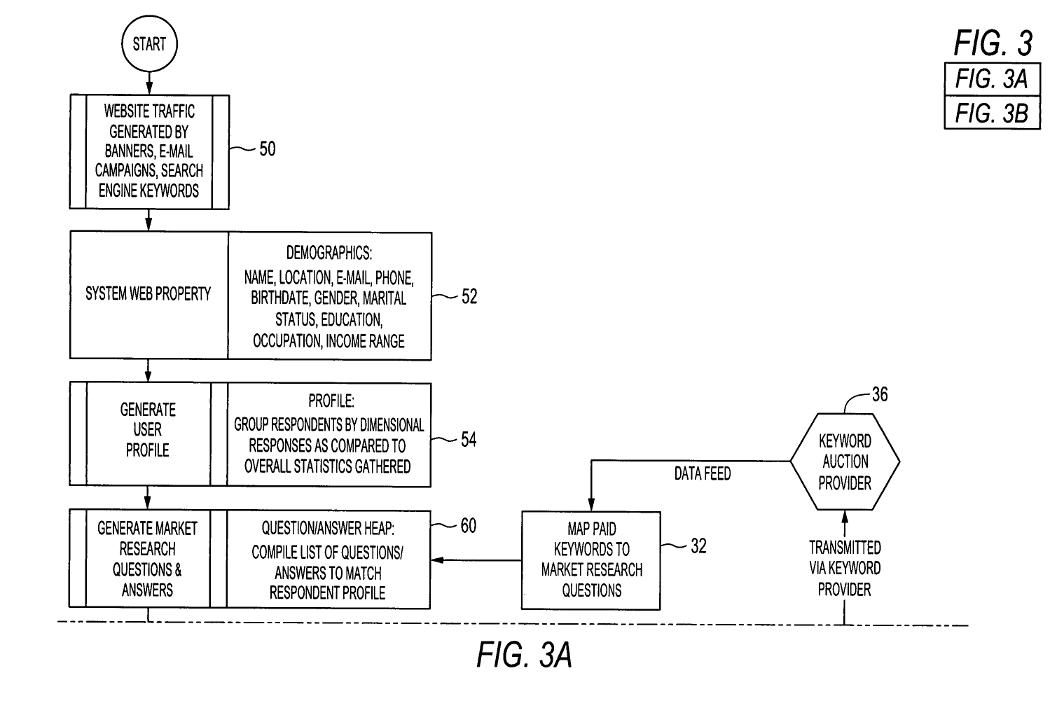

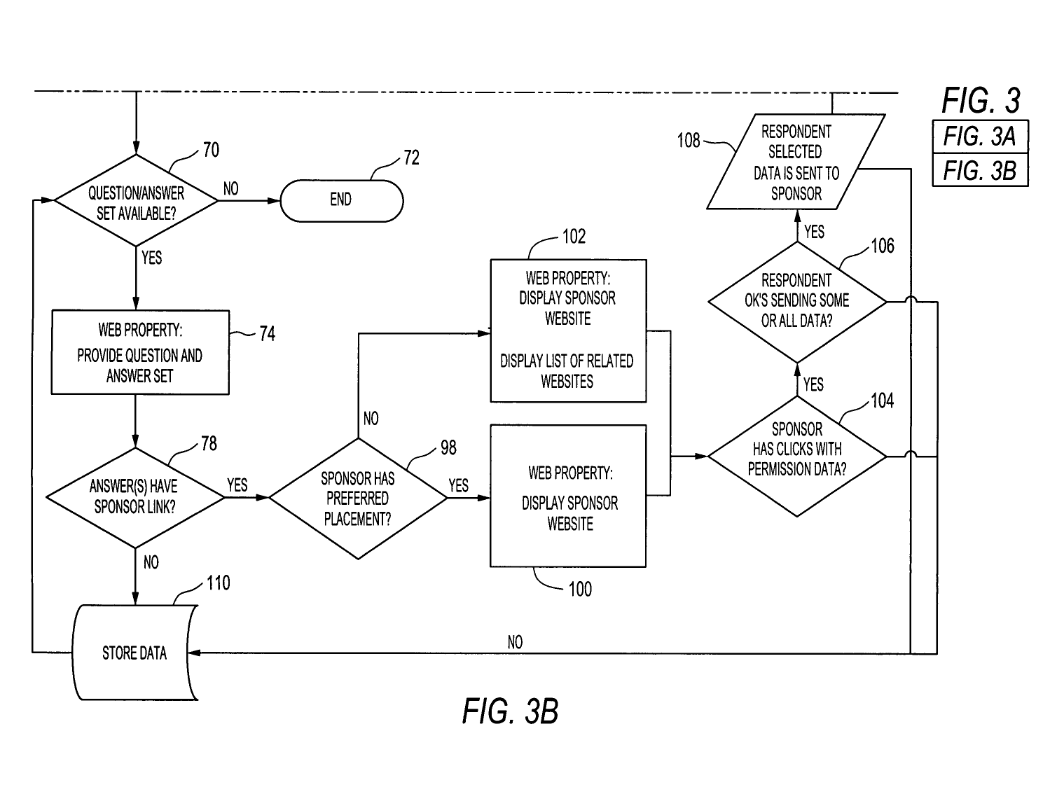

FIG. 3 shows information flow among the user 24, the interactive online research system 20, and the KAP 36. The user 24 is directed (step 50) to the Web property 30 to submit research survey data. The user may be, for example, directed to the Web property 30 by banners, e-mail campaigns, search engines, etc. In a preferred embodiment, the user 24 may be motivated to respond to a particular survey by use of incentives. For example, a particular survey presented by the Web property 30 may be associated with a sweepstakes entry, samples, coupons, cash payments, and/or points in a point system that is redeemable for particular items. One or more of these incentives may also provide the additional benefit of further connecting a particular sponsor and the user 24. As further incentive, the Web property 30 preferably provides an interactive environment for the user 24, and allows him or her to become a “member”. More particularly, the Web property 30 may be designed to create an environment in which the user 24 can access or log onto the Web property 30 to obtain information, conduct transactions, receive offers, etc.

A Web page of the Web property 30 is presented to the user (step 52) to start the interactive session. To optimize questions and determine Web sites and documents for a particular user 24, a user profile is generated (step 54) and stored in the database 34, based on information submitted by the user via the Web property 30. The user profile includes demographic and preferably interest information that is grouped by individual dimensional responses, as opposed to overall statistics. The data contained in the user profile is used for determination of survey questions and questions to be presented. The user profile is preferably accessible to the user 24 at least with regard to a username, password, and certain identifying data, such as, but not limited to, a last name, address, telephone, e-mail address, education, occupation, and household income (or income range). Other, static data (e.g., birth date) may or may not be accessible to the user 24 to update, but may be available for correction, for example.

Based on the user profile, one or more questions are retrieved from the database 34 and presented to the user 24 via the Web property 30 (step 60). Preferably, each survey (question set), question, and answer that is provided to the user maintains a field profile in the database 34, referred to herein as a survey profile, a question profile, and an answer profile, respectively. The profiles are used in presentation of the survey questions as well as for displaying listings for sponsors' Web sites or documents. A question profile may include, but is not limited to, one or more ratings pertaining to the desirability of the question, and a description of the order in which predefined answers to the particular question are presented (e.g., alphabetical, specific order, random). A question is preferably identifiable within the database 34 by a question identifier (“QID”).

For the ratings, the question profile preferably includes a ‘calculated appeal’, which is calculated as the frequency with which it can be expected the user 24 will select any mapped answer identifier (“AID”) from the current values belonging to a particular question; and a ‘calculated value’, which is calculated as the most valuable combination of a single AID frequency and cost-per-click (CPC) for each of the mapped AIDs belonging to a question. A manually-entered preference rating preferably is also provided for each question. This preferably numerical value is used to force particular questions based on upon sponsor arrangements or decisions by the operator, for example. The preference rating allows an operator to supercede the calculated values for certain questions, pages or surveys by providing, for example, a numerical rating between −10 and 10. In this way, a new survey with no historical data can be forced ahead of other more established surveys in the interactive session, or conversely, a survey deemed to have inappropriate, for example, very invasive questions could be forced to be behind others in the session, despite a very high calculated appeal and value.

The answers, identifiable within the database 34 by an answer identifier, preferably follow a similar profile (answer profile), with certain differences. The answer profile may include, for example: an AID frequency which is calculated as the likelihood of any user to select a given AID (which preferably automatically takes into account factors such as the degree to which the presentation of a question is targeted to certain users); and a maximum CPC value for current KAP supplied keywords. The answer profile also preferably includes an order ranking, which reflects an order of how answers are listed in association with a particular question (if a specific order is allowed according to the question profile).

The answers within each question preferably are the most prominent component of the logic points used to dictate the interactive session for the user 24. For example, selection of a certain AID may cause a compiled trigger to queue up a specific survey, page or question for a user.

The answer profile also includes or is associated with a table of possible keywords for searching mapped to the answer. Preferably, this table includes all of the possible keywords for a specific AID, which may be input manually or via an automated source. However, a number of the keywords according to a preferred embodiment are supplied by the keyword auction provider 36. The table of possible keywords preferably includes, for each sponsored keyword, a current maximum value for that keyword as provided by the keyword auction provider 36. The table further includes a finite number of corresponding links (e.g., URL's) to Web sites or documents for each keyword. The table preferably includes the ability in certain cases, if selected, to see the sponsor's sites without using a paid link, i.e., without the keyword auction provider information. The table may also include, among other things, a check radio button or other control to select one of the chosen search terms. The table may (and preferably does) include pointers to other tables to retrieve information as well.

The answer profile preferably further includes an ability to select a unique window type for display of a retrieved site associated with that answer. The window type may include, for example, an automatic display of the highest ranked sponsor, an opaque display of the highest ranked sponsor, or a list of sponsored sites or documents.

Research survey questions within an interactive session are preferably presented based upon the entry of the demographics as well as general interests of the user (of a mass audience, for example). These questions may be in various formats, such as, but not limited to: questions that can be responded to by one or more selectable, predefined answers; questions that can be responded to by a single specific, pre-defined answer; questions that can be responded to by a free text entry; and questions that can be responded to by a combination of these answers.

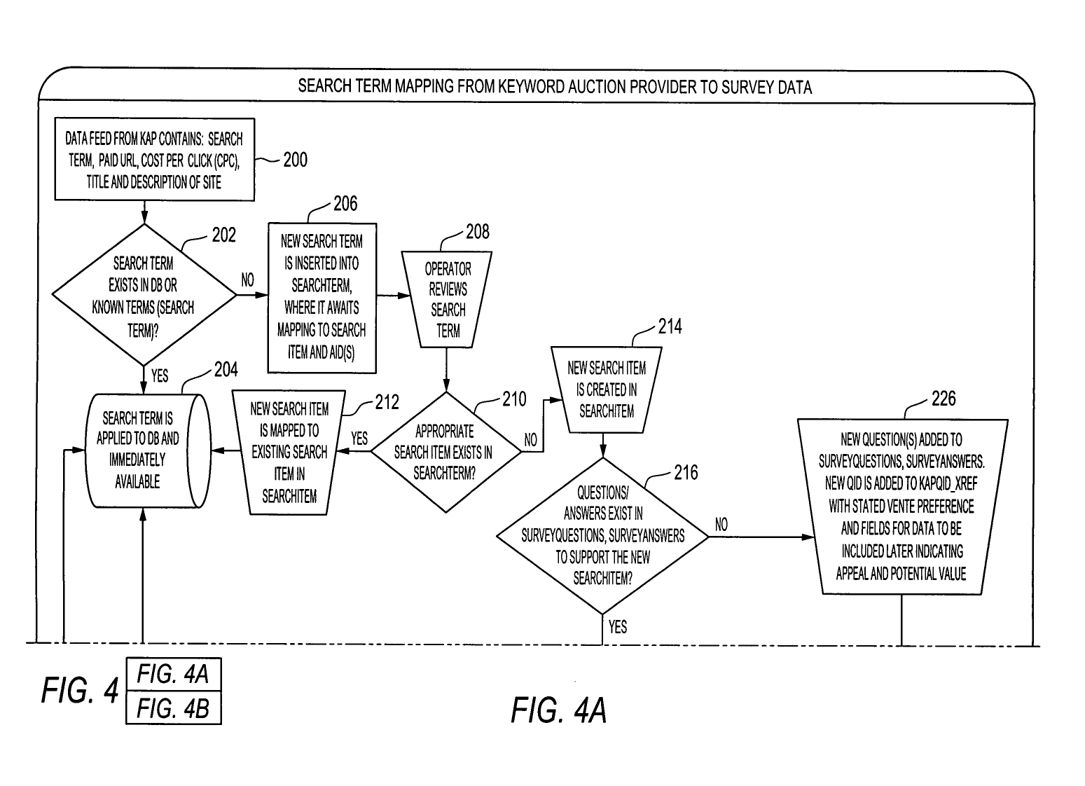

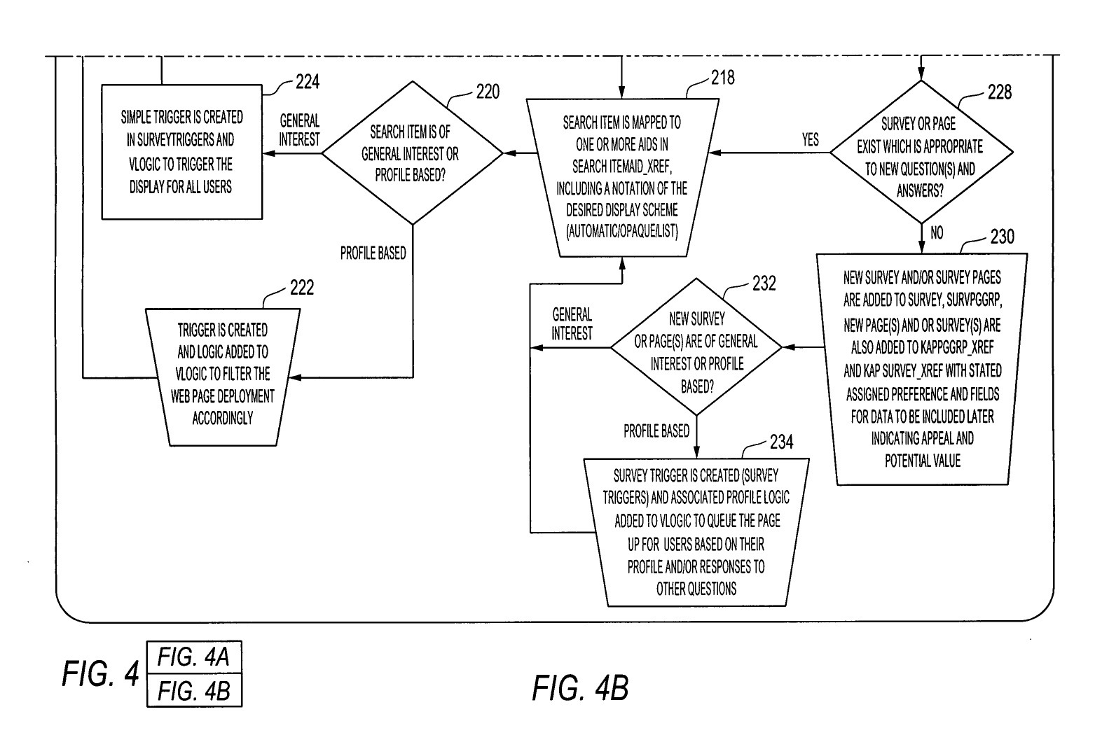

FIG. 4 shows an exemplary method for associating keywords (and thereby Web page or document links) to answers, by mapping keywords provided from the keyword auction provider 36 to the answer profile. The interactive online research system 20 receives a data feed from the keyword auction provider 36 (step 200) containing, for example, a keyword including keyword combination (search term), a sponsor's URL, a cost-per-click, a title associated with the link (for displaying with a list of links), and a description of the site (also for display). For each keyword, the database 34 is queried (step 202) to determine if the keyword already exists in the database. If so, the keyword and associated data are applied to the database 34 and immediately made available to the system 20 (step 204).

If the keyword is not present in the database 34, the keyword is placed (step 206) into a table (for example, table “searchTerm”), where it awaits mapping to a particular search item, and thus to an answer identified by an AID. The search item is a root term for linking several logically related keywords, so that they in turn may be linked with an appropriate answer. The interactive online research system 20, preferably with some manual input by an operator, reviews the keyword (step 208), and determines whether an appropriate search item is present (step 210) for mapping to the keyword. For example, the KAP 36 may provide URL's for keywords ‘cue stick’ and ‘billiard cue’. These two keywords could be mapped to a single search item, ‘pool cues’. If a new keyword search is received with either keyword, it will automatically be mapped to the “pool cues” search item.

If, however, a value is received from a KAP 36 with a keyword of, say, ‘billiard cue stick’, it may not automatically be recognized by the interactive online research system 20, and thus the operator builds an association with the ‘pool cues’ search item. Preferably, an operator interface of the interactive online research system 20 is configured to suggest likely matches to the operator for the mapping. After the new keyword is mapped to the existing search item (step 212), the keyword is made available (step 204).

If an appropriate search item is not present, a new search item is created in an appropriate table, such as table “searchItem” (step 214). The survey questions in the database 34 are then reviewed to determine whether survey questions or answers exist to support the new search item (step 216). If so, the new search item is mapped to one or more answers (step 218) through their answer identifiers, for example in a table such as table “searchitemaid_xref”. A preferred type of display for the sponsor's URL is noted in the table.

Preferably, it is determined whether the search item is of general interest or more user profile based (step 220). If the search item is more profile based, a trigger is created, and logic is added to a logic table to filter deployment of Web sites accordingly (step 222). If the search item is of general interest, a simple trigger is created (step 224) for all users to trigger display of a Web site using the logic table. After creating an appropriate trigger, the keyword associated with the mapped search item is made available for providing linked Web sites (step 204).

If no questions or answers exist to support the new search item, one or more new questions and answers is added to suitable tables of survey questions and survey answers (step 226). Once a new question is created and added, a new question identifier is added to a table of identifiers, for example, table “kapqid_xref”, along with a manual preference rating (if any), calculated appeal, and/or calculated value. It is next determined if an appropriate survey (question set) or survey page (of an existing survey) exists for the newly-created question (step 228). If so, the search item for the new question is then mapped to one or more answers (step 218). If not, a new survey and/or new survey pages are added (step 230). Similarly to creation of a new question, it is determined whether the newly-created survey or survey page is profile based or is of general interest (step 232). If the new survey or survey page is profile based, a survey trigger is created, for example, in a suitable table, and associated logic is added to the logic table to queue the survey or survey page for the user 24 based upon the user's profile and/or the user's response to other questions (step 234). Afterwards, or if the new survey or survey page is of general interest, the new search item (and thus keyword) associated with the new survey or survey page (and new question) is mapped to one or more answers as described above (step 218).

It may be desirable in particular cases to link a particular Web site or page directly with an answer identifier. This forces return of the directly associated Web site or page upon selection by the user 24 of that answer choice.

In certain embodiments, the interactive online research system 20 can be layered on top of a traditional search engine. The system 20 may be integrated, for example, via the mapping system 32 where the keywords associated with an answer identifier are retrieved within the database 34, and electronically passed to the traditional search engine. The traditional search engine initiates a search based on the supplied keyword (including keyword combinations) and the results are integrated back into a unique window of the Web property 30 to display the results. This solution is another way to provide both sponsored and non-sponsored results as with the normal operation of a traditional search engine.

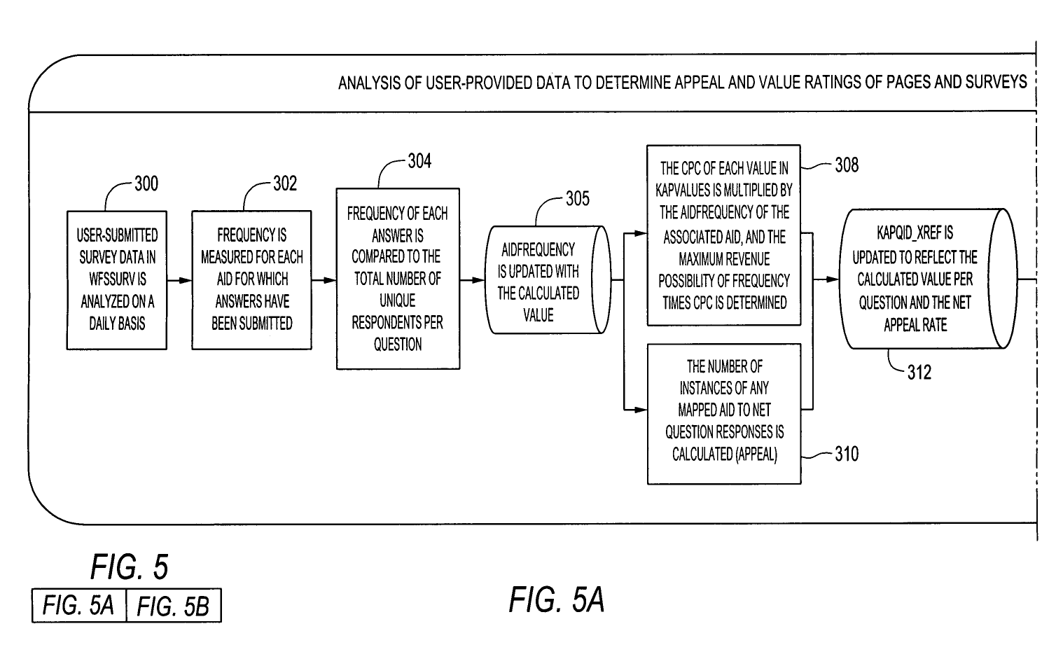

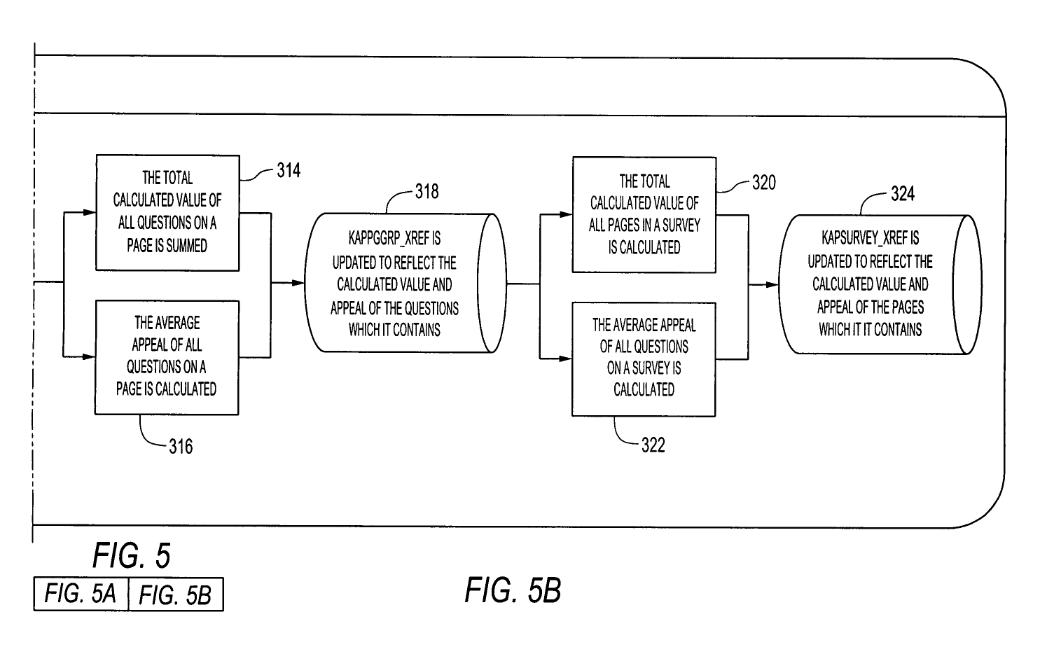

Referring again to FIG. 2, a survey optimizer 42 optimizes survey questions based upon, for example, demographical information provided by the user 24, as well as ongoing data collected during interactive sessions regarding interests of the user. FIG. 5 shows an exemplary process for analyzing data provided by the user 24 to determine appeal and value ratings of surveys and survey questions.

In the process shown in FIG. 5, user-submitted data in response to a survey is analyzed periodically, for example on a daily basis (step 300). A frequency is measured for each AID corresponding to answers that have been received from users (step 302). The frequency of each answer is compared to the total number of unique users for each question (step 304). This frequency value is used to update a table such as “aidFrequency” (step 306). The cost-per-click (CPC) of each value for the keyword values is then multiplied by the frequency calculated in step 306 to determine a maximum revenue possibility for a keyword (step 308); i.e., the calculated value. Also, the number of instances of any mapped answer to net question responses is calculated to determine a calculated appeal (step 310). The database 34, for example a table “kapqid_xref” is updated to reflect the calculated value per question and a net appeal rate for the question (step 312).

For example, a question may have four AIDs, each being mapped to one or more KAP values. If, for example, AIDs belonging to the question are selected by users with a frequency of 10%, 15%, 20% and 25%, respectively, and the KAP provided URLs for these AIDs carry CPCs of $0.10, $0.20, $0.30 and $5.00, respectively, each of the frequencies is multiplied by the maximum CPC values for the given AID so that the calculated value is determined to be $0.25 for the question. This is because the highest CPC is obtained by the 5% of users selecting the last of the AIDs, mapped to a CPC value of $5.00, which equates to the greatest revenue potential for the question, despite the lower frequency of selection of that AID.

Next, the total calculated value of all questions in a page is summed (step 314), and the average appeal of all questions on a page is calculated (step 316). For the page, therefore, the database 34, such as a table “kapPgGrp_xref” is updated to reflect the calculated value and the appeal of the questions the page contains (step 318).

The total calculated value of all pages in a particular survey then is calculated (step 320), and the average appeal of all questions in a survey is calculated (step 322). Thus, for the survey, the database 34 is updated, for example via a table “kapSurvey_xref”, to reflect the calculated value and appeal of a survey having these pages (step 324). Accordingly, values are calculated for answers, questions, pages, and surveys, which can then be selected according to a weighting based on user appeal and remuneration to the operator of the interactive online research system 20.

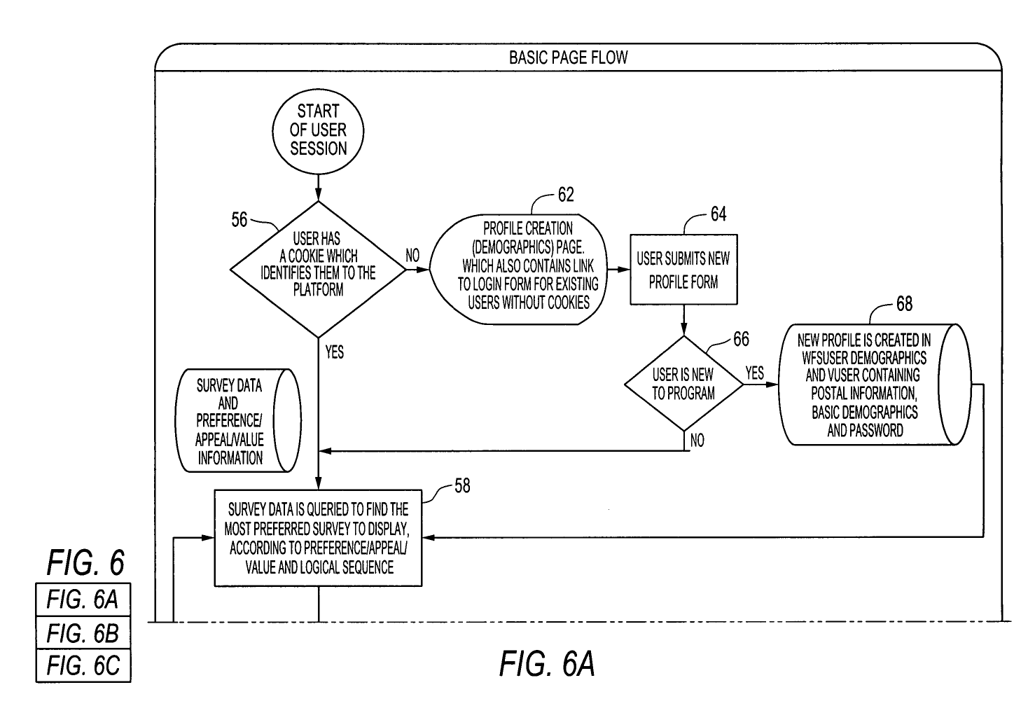

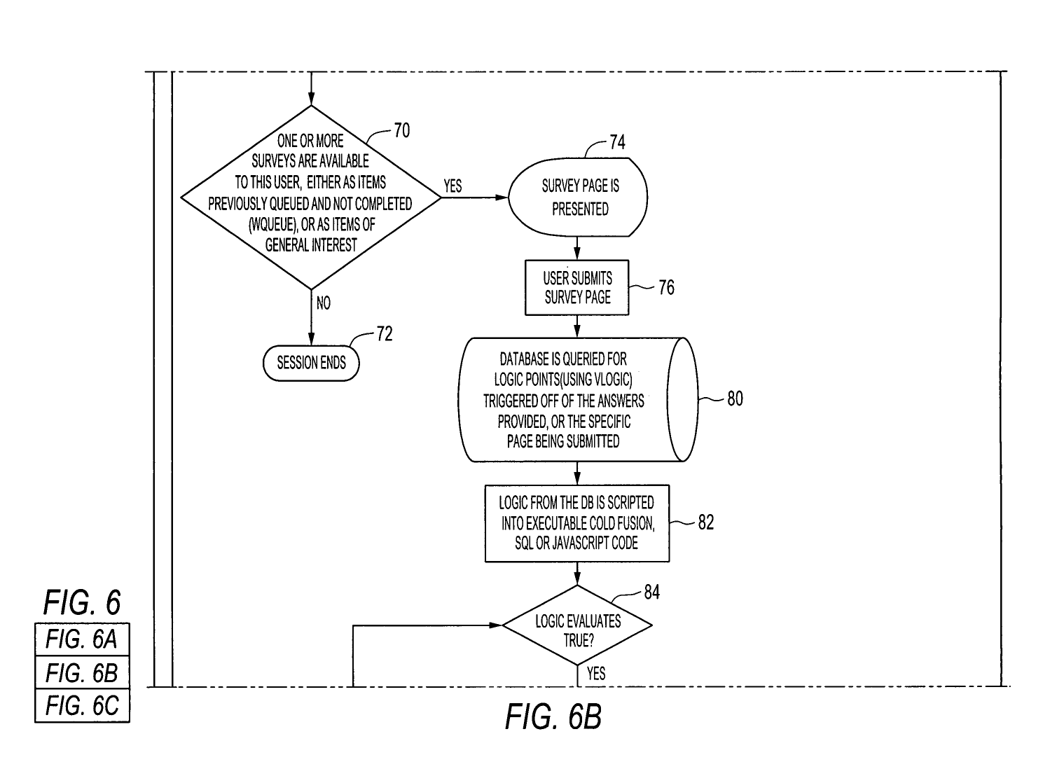

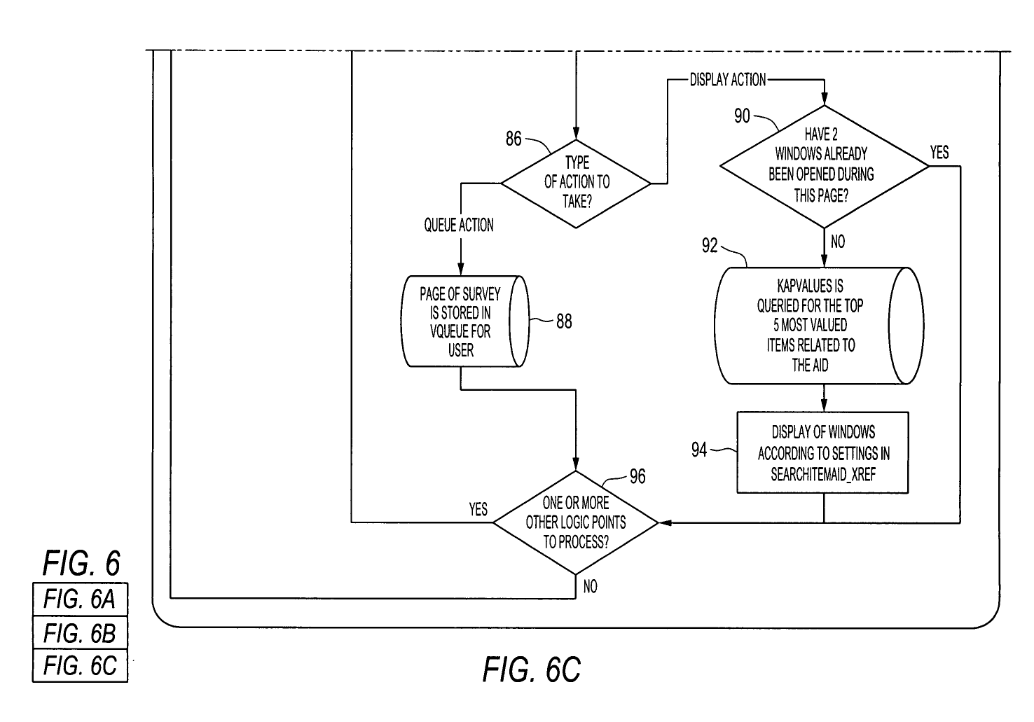

FIG. 6 shows a basic page flow of the interactive online research system 20 to generate displays of online sites or documents, shown by example as Web sites, during an interactive session. At the start of an interactive session, if a cookie is present on the user's computer (step 56) identifying the user 24 to the interactive online research system 20, or if other identification is presented to the system, survey data from the database 34 is queried (step 58) to find the most optimal survey to display according to the values assigned to questions and answers, as described above, according to a profile of the user, and/or by logical sequence. Based on these values, a list of questions forming a survey is retrieved and presented to the user within a Web page (a survey page) (step 70).

If no identification for the user 24 is found by the interactive online research system 20, or if incorrect or incomplete user information is present, the interactive online research system generates or updates the user profile. A profile creation page having a profile form is displayed within the Web property 30 (step 62). The profile creation page may also contain a link to a login form for users already with created user profiles, but without cookies stored on their computer. The user 24 may be presented with a challenge to enter the Web property 30. The page may allow a user to retrieve a password by e-mail if necessary (for example, if the user forgets the password). If the username and password are selectable by the user 24, an e-mail address preferably is also received upon entry for security. In a preferred embodiment, passwords may be encrypted with a known key and decrypted when sending out passwords by email to a user. To receive a password initially, a user may be required to enter identifying information, such as a city of residence, ZIP code, and/or birth date. Alternatively or additionally, the system 20 may be configured to generate a password and e-mail it to the user 24. A cookie or other identifier may be used to store an e-mail address for the user 24 on the user's computer, for example, but it is preferred that the cookie not store a password to enter the system for the purpose of updating the user profile.

To update or create a user profile, the user 24 fills out and submits the profile form (step 64). If the user 24 is new to the interactive online research system (step 66), a new profile is created in an appropriate location within the database 34 (step 68) containing information pertaining to the user. Also, general demographics for compilation purposes, for example, may be stored in a separate location. If a (correct) profile has already been created for the user, 24, this step is skipped.

Referring to FIGS. 3 and 6, survey questions are then made available to the user (step 58) via a survey page of the Web property 30. The interactive online research system 20 queries survey data for questions and answers that may match with a particular user's profile (step 58), and it is determined whether an appropriate question and answer set is available (step 70). More particularly, it is determined whether a survey exists that is either previously queued and not completed (for example by querying an appropriate table in the database 34), or if items of general interest are available. If not, the interactive session ends (step 72). If so, the survey is presented to the user 24 (step 74).

Questions within the interactive session are offered to the user 24 based on the question profile described above, and are preferably matched against data of the user (such as demographic data), and against a number of functions. These functions may include, but are not limited to the calculated value, the calculated appeal, and the preference rating. The answers to the questions are provided in alphabetical, specific, or random order as specified in the question profile (and in the case of a specific order, as may be specified in the answer profile).

The questions and possible answers (or blanks for free data entry) in a particular survey are presented to the user 24 (step 74) through a survey page of the Web property 30. The user 24 then answers the provided question or questions, and submits the response (step 76) to the online interactive research system 20, via an appropriate control. Alternatively, an automatic retrieval of answers is conducted. In a preferred embodiment of the present invention, for example, a calculation field is provided for each AID, such as two seconds per answer identifier, and this calculation is multiplied by the number of answer identifiers for a particular question. After a period of time (the time calculated above, for example) has elapsed, the received answers are evaluated to determine which Web sites, links, or documents will be provided.

Once received by the interactive online research system 20, the individual questions and answers are evaluated (step 78) preferably both manually and automatically to determine whether appropriate keywords have been selected. Particularly, and preferably, appropriate answer identifiers may be used to direct the user to a Web site based upon the stored logic points to select the most likely desirable Web site according to interest of the user 24. Furthermore, real-time user profiles are preferably created or updated using the received answers for offering additional questions and answers that are of likely interest to the user.

As an example of this evaluation, the database 34 is queried (step 80) for logic points that are triggered from the answers provided by the user 24 and/or by the specific survey pages being submitted to the user. The retrieved logic points are scripted into executable code (step 82) using a suitable program. Each logic point is then evaluated to determine whether it is associated with a link to a sponsor's site or other Web site or document (step 84). If not, the next logic point is analyzed.

If the logic evaluates true (i.e., there is an associated link present), two actions preferably occur (step 86). In one action, the page or survey is stored in a queue table within the database 34 linked to the user (step 88). In a second action, it is determined whether a predetermined number (for example, two) of Web sites have been displayed (step 90). If not, the database 34 (for example, a values table for the keyword auction provider) is queried (step 92) for a certain number (five, for example) of most-valued items related to the particular answer being evaluated.

A window of a Web site or other site or document related to the retrieved items is presented to the user 24 (step 94) according to settings stored within the database 34, for example, within the table mapping the appropriate search item with the received answer. At this point, it is determined if there are additional logic points to process (step 96). If so, these additional logic points are evaluated (step 84). If not, an additional survey question may be selected and displayed (step 58).

At any time after the user 24 has provided one or more survey answers so that the online interactive research system 20 has keywords linked to one or more selected documents or Web sites, and preferably after a first selection of such a survey answer, the user preferably is presented with the Web site linked to that keyword or keyword combination by the Web property 30, and thereby linked to the survey answers (or questions). The presented site may be, for example, a first site in terms of priority among sponsored sites with links to the survey answers or questions.

In a preferred embodiment of the present invention, the online interactive research system 20 provides sponsors with the ability to request (or purchase) exclusive or preferred traffic (i.e., clicks) to sponsored Web sites through created user profiles. For example, based on selected questions and answers that are indicated to be exclusive or preferred, a sponsor's site link may be given top priority in a list of provided links, and/or the user 24 may be sent directly to the sponsor's site, preferably within a frame. If an exclusive arrangement is selected, only the sponsor's site link is provided to the user 24. This option of exclusive traffic allows, among other benefits, data delivery to a sponsor, a redirect to a sponsor's Web site, and/or other custom solutions. A limited period for exclusivity may be set, after which the selection of exclusivity of preference may be removed for that particular question or answer.

Referring to FIG. 3, if a linked Web site has preferred or exclusive placement (step 98), the display window of the Web property 30 preferably displays only that particular Web site (step 100). Otherwise, the Web site is displayed, along with a list of related Web sites found during the evaluation process (step 102).

Preferably, a limited number of sites are provided to the user 24 for a particular question (even if the number of answer identifiers is large). A list of additional keywords related to answer identifiers not used in selecting sites may be presented to the user 24 so that he or she may select one or more items in the list to retrieve additional information relating to a particular keyword (or the keyword itself).

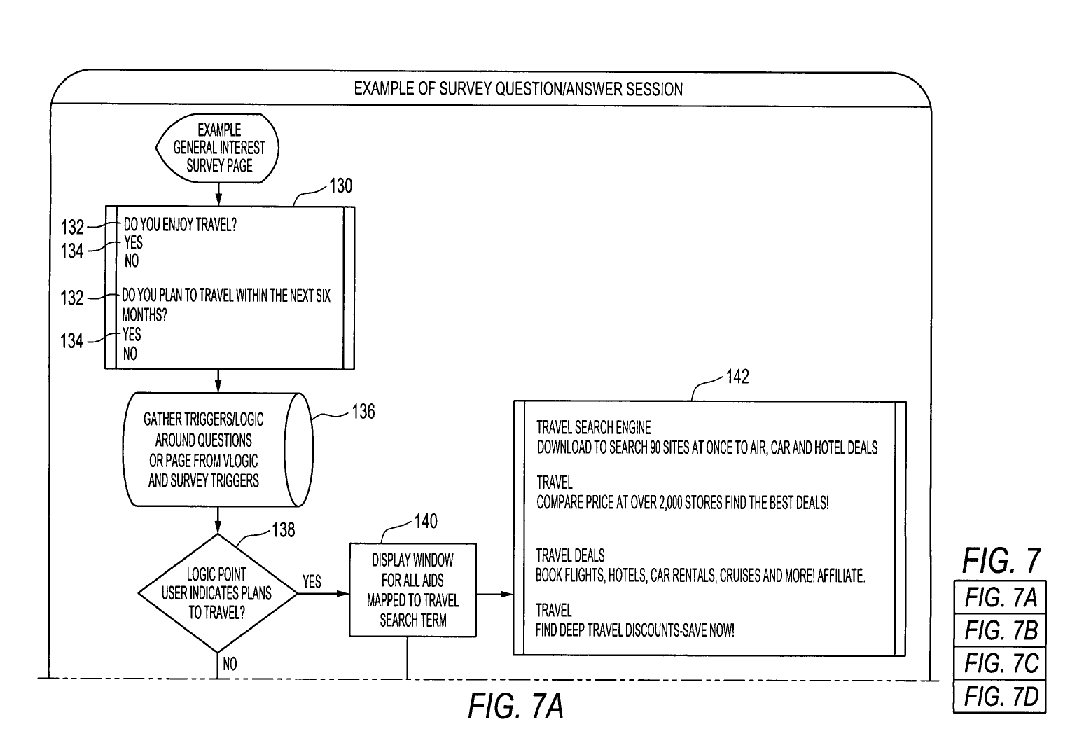

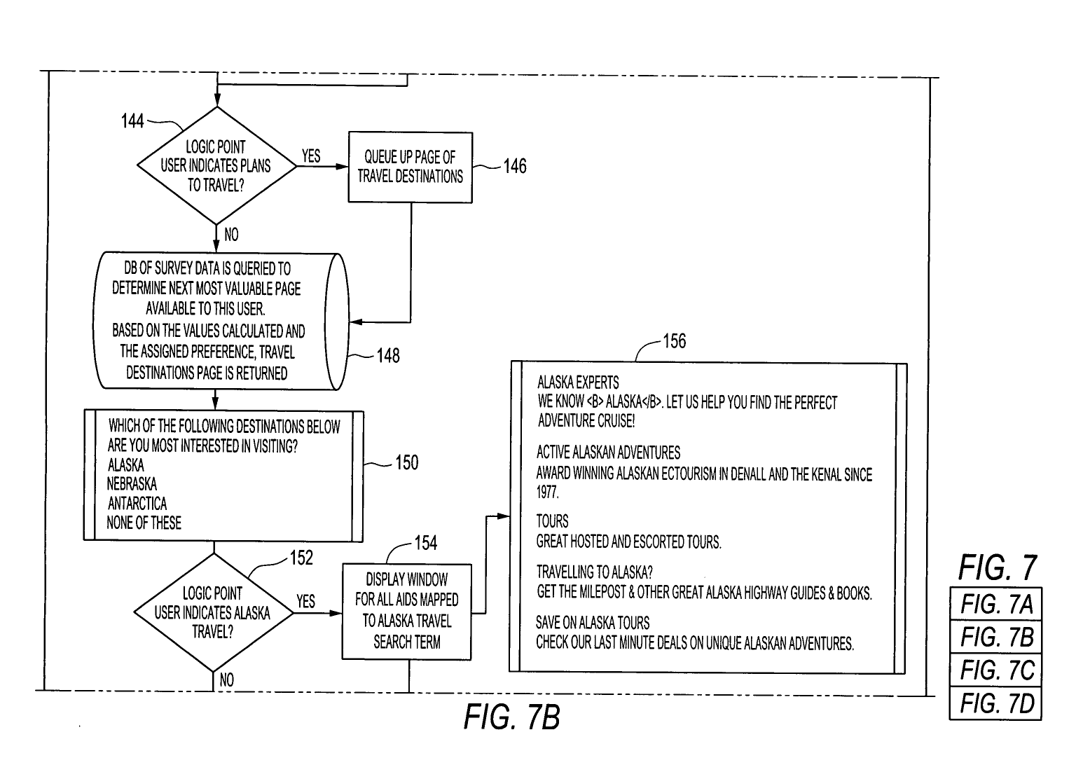

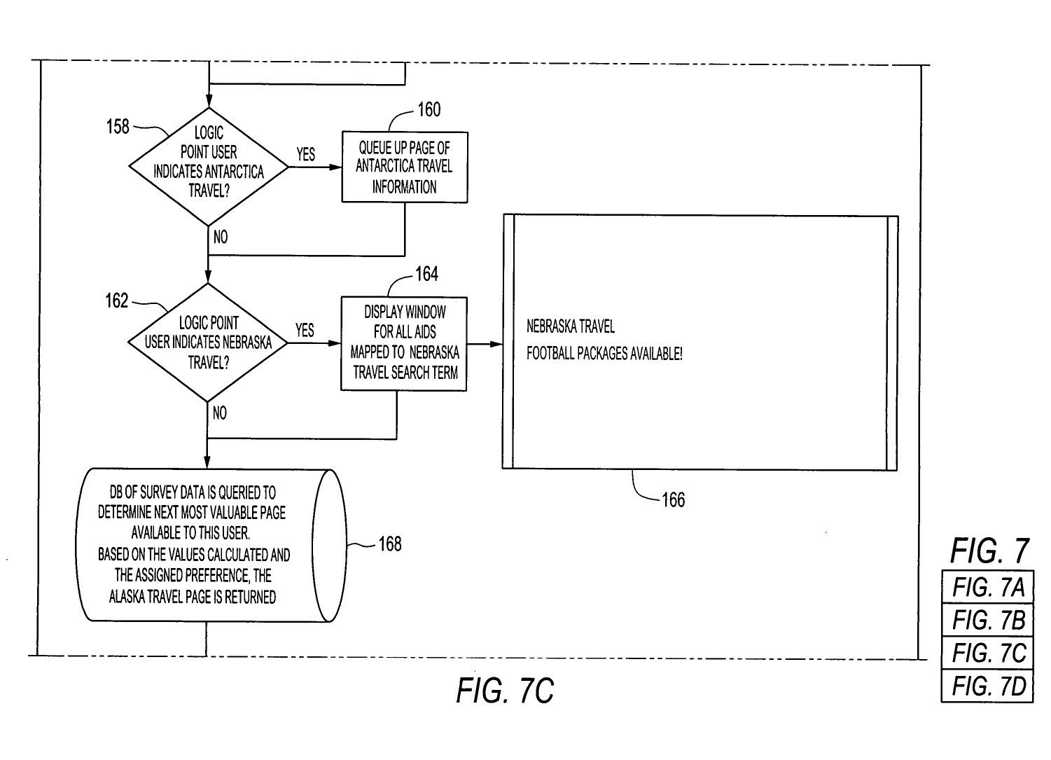

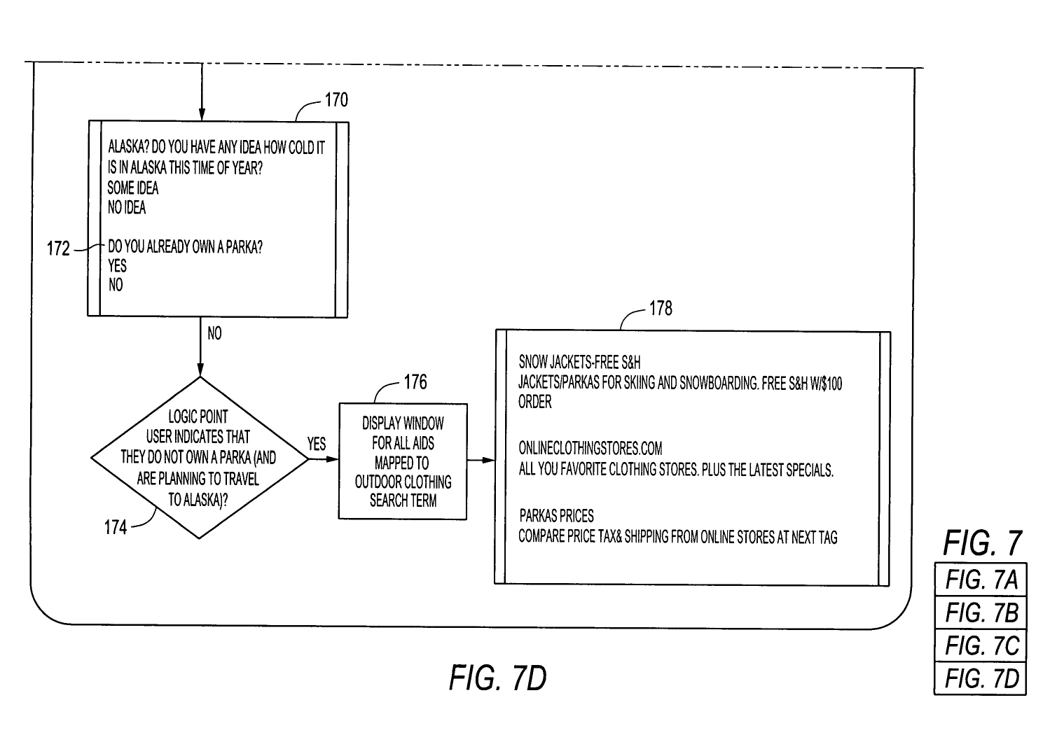

FIG. 7 shows a sample survey question and answer session. As shown in FIG. 7, a survey page 130 of the Web property 30 is shown having a pair of questions 132, each having a pair of predefined answer choices 134. The first question 132 asks if the user enjoys travel. The second question 132 asks if the user 24 plans to travel in the next six months. The user 24 selects one of the answers 134 to one or both of the questions 132, and the answers are submitted via suitable methods to the interactive online research system 20. The interactive online research system 20, receiving the answers 134, gathers triggers/logic points around these questions or this page from logic tables in the database 34 (step 136).

Analyzing one first logic point, if the logic point determines that the user 24 plans to travel (step 138), a Web site or document is provided (e.g., a link is displayed) by the Web property 30 for all answer identifiers that are mapped to a “travel” keyword (step 140). A sample Web site is shown at 142. The next logic point is analyzed to determine if the user 24 plans to travel in the next six months (step 144). If so, a number of Web sites directed to travel destinations are queued (step 146).

At this point, the database 34 having the survey data is queried to determine the order of Web site pages to display according to calculated values and/or manual preference, and the Web site pages are provided in the determined order. (step 148). Next, another survey page is returned to the user 24, as shown in page 150, which asks which state the user is most interested in visiting, and the answers provided are “Alaska”, “Nebraska”, “Antarctica”, or “None of these”. The user 24 then responds, and the answer is submitted to the interactive online research system 20.

If the logic point gathered indicates Alaska (step 152), a list of Web site pages is generated for this answer identifier, which is mapped to keywords “Alaska travel” (step 154), and displayed to the user, a sample list being indicated at 156. In step 158, if it is determined that the logic point indicates “Antarctica”, the interactive online research system 20 queues pages related to keywords “Antarctica travel” (step 160). If, instead or additionally, the logic point indicates Nebraska travel (step 162), the user will be directed to a different Web site or list of Web sites (step 164), an example of which is shown at 166.

In a particular embodiment, searches may be enhanced through the use of user-provided demographics. In such an embodiment, these demographics may be appended or mapped to other keywords which in turn are used to generate search results based upon the answer identifier. For example, the user 24 indicates that he or she is seeking a “local realtor” by checking an appropriate answer identifier. The interactive online research system 20 then utilizes the user-supplied demographic information (e.g., in the user profile) in order to create a dynamic mapping of this answer identifier. If the user 24 indicates that he or she is from “Chicago”, the system 20 creates a dynamic mapping to a keyword set of, for example, “realtors Chicago”. This dynamic mapping preferably can utilize any or all of the demographic information provided as well as data from previously answered questions within the interactive online research system 20.

Next, in the sample survey session illustrated, the database 34 is queried for survey pages to determine a next most valuable page available to the user 24, based on calculated values, manual preference, etc. (step 168). Accordingly, a new survey page, indicated at 170, is displayed to the user 24 with additional, follow-up questions. For example, the second question 172 asks whether the user 24 already owns a parka. Once the user 24 responds, if a logic point indicates (step 174) that the user does not own a parka, but is planning to travel to Alaska (as indicated from an earlier logic point), a list of links for all answer identifiers mapped to an “Outdoor clothing” keyword is produced and displayed to the user 24 (step 176), a sample list being indicated at 178.

In a preferred embodiment of the invention, the presented site is displayed in a frame within the displayed page of the Web property 30, as opposed to via a separate pop-up or pop-under. Links to other sponsored Web sites or other, non-reserved sites may also be displayed within the displayed page of the Web property 30. By providing all user interfaces within a single window, the user 24 is given a more smooth transition between selected and presented sites or documents during an interactive session.

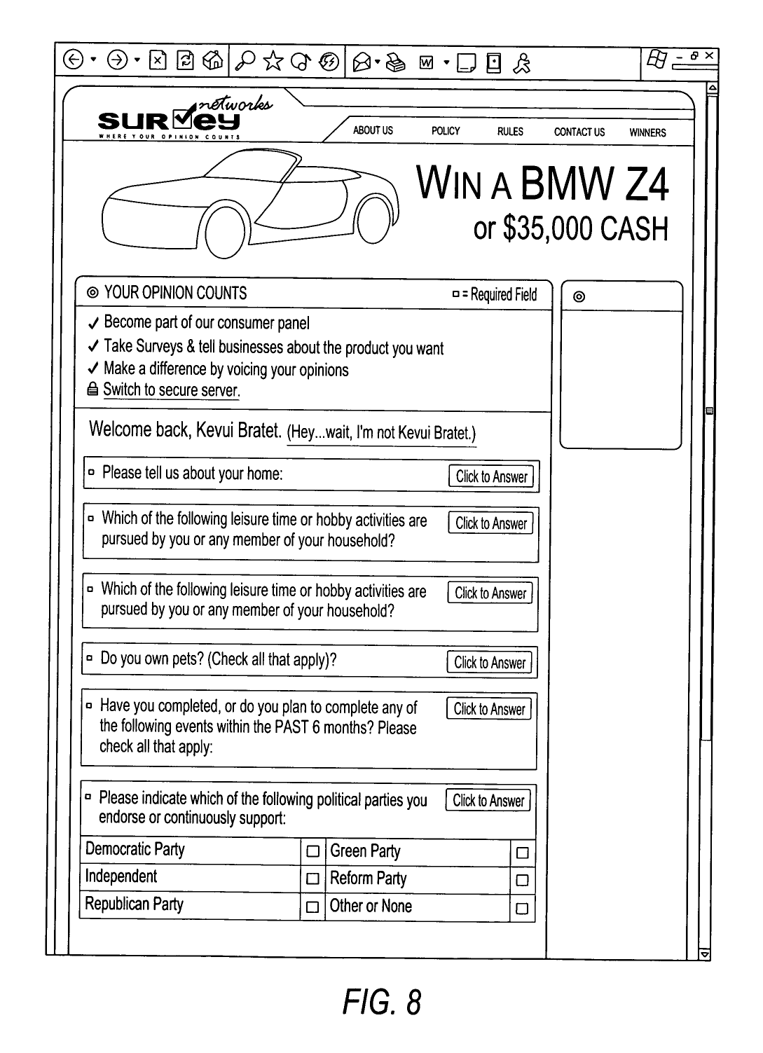

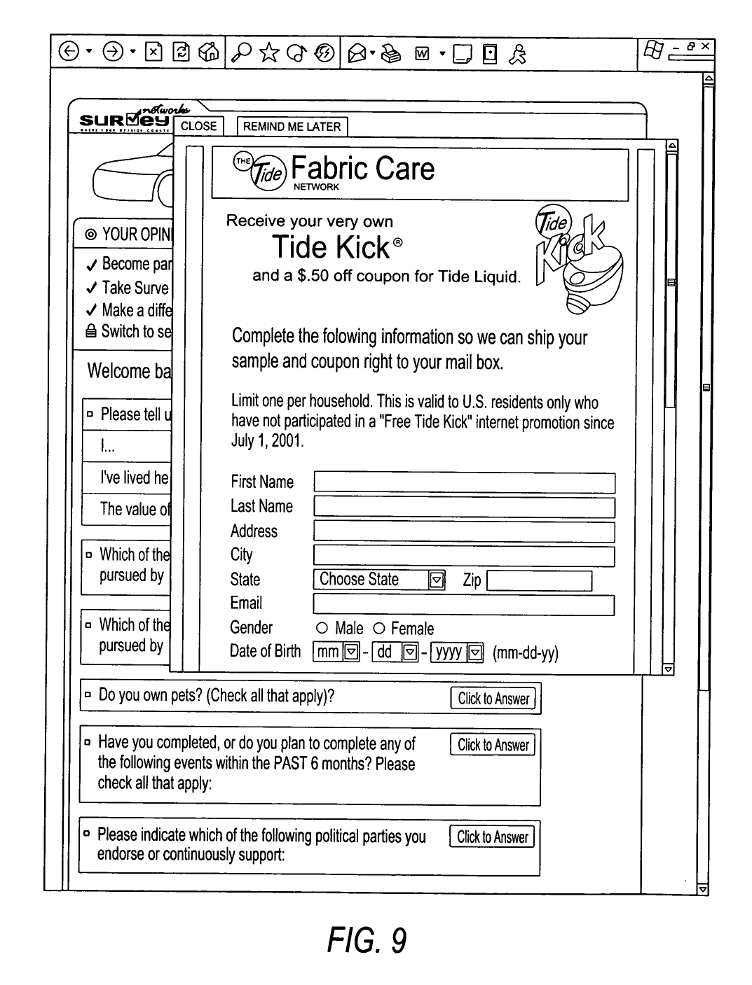

In a preferred embodiment of the present invention, a selected Web site, document, or link is presented to the user 24 by the Web property 30 in one of various ways. For example, a particular site found via keywords, either sponsored or non-sponsored (as selectable by an operator) is displayed to the user 24. The user interface display of the Web property includes a separate window or frame displaying a Web site to which the user 24 has been redirected. As shown, the Web site is preferably presented to the user 24 within the Web property 30 so that it is within the current browser being employed by the user, without the use of a separate Internet browser, a pop-up, or a pop-under. Examples of such a display are shown in FIGS. 8-9. FIG. 8 shows a sample survey page within a window of the Web property 30, and FIG. 9 shows the same page partially overlaid by a sponsor's Web site.

It is preferable that the frame used to display the Web property 30 for the user 24 is prominent to the user so that a separate browser is not necessary, yet not so prominent as to completely obstruct the Web property page also being displayed to the user. For example, the separate display (frame or window) preferably does not take up more than 50% of a field of vision for a user interface Web page (e.g., an 800×600 display) of the Web property 30. The separate display preferably includes scroll bars or other controls for navigating the separate display. However, it is also preferred that the separate display not have other browser controls available, as the separate display is preferably not intended to have the look and feel of a separate browser, but instead a portion of the page of the Web property 30.

Additional Web sites or links may be provided inside of the user interface display to facilitate the user's switching between Web sites. An additional link may be provided to produce a list of additional search results for one or more keywords. Preferably, further clicks to these additional Web sites are presented within the same window of the Web property 30, along with an option to retrieve further sites. In this way, a preferred embodiment of the Web property as a user interface permits browsing and interaction among Web sites found as a result of a target search without negotiating additional browser windows in the user's display.

An alternative type of display of the Web property 30 includes a Web site or document selected as described above, displayed within the window of the user interface, but purposely made partially or completely opaque so that it cannot be easily viewed by the user 24 without a separate action on the user's part. For example, the display of the Web property 30 may be 50-75% opaque so that is legible or somewhat legible, but not clear.

In a preferred embodiment, an opaque Web site display is presented by the Web property 30 that is similar in format to the display described above, but in which the URL of the site (such as a sponsor's site) does not reference a sponsored click-through. This can be done, for example, by parsing out a portion of the URL within the related answer profile that references the KAP 36.

In addition to the opaque display, a separate control, such as a large link or widget is displayed, for example placed over the opaque display. This separate control allows the user 24 to elect (by clicking) to view the Web site of the opaque display. If the user 24 clicks the separate control, the opaque display is reopened as a typical (clear) display, using a full URL, including the associated information supplied with by the keyword auction provider. In this way, the operator of the interactive online research system is given credit for linking the user 24 to the displayed Web site.

Instead of or in addition to displaying a clear or opaque Web site or document, the Web property 30 may provide a separate frame displaying a list of search engine results. For example, the search engine results may include a limited number of sponsored sites in a particular order (e.g., sponsorship amount), and/or a list of non-sponsored sites found via a search of Web sites using the keywords selected by questions answered during the interactive session. Preferably, the links are full URL's, with keyword auction provider information, which can be used to click-through to a Web site. If a user 24 clicks a link, a clear frame as described above preferably is displayed having the selected Web site along with the additional list of sponsors, as with other versions of the display.

Referring again to FIGS. 1 and 3, once a sponsor's site is displayed, if it is verified (step 104) that a sponsor's Web site includes entry of permission data (for example if the sponsor has paid for the ability to allow this service), the interactive online research system 20 allows a user 24 to permit submitting data (step 106) to the sponsor and/or conduct transactions with the sponsor. For example, the user 24 may provide to the sponsor one or all of an e-mail address, postal address, and phone number.

It is preferred that the interactive online research system 20 including the Web property 30 provide the user 24 with full control over the submission of information, and that no automated data streams are used. For example, each item of information may be submitted by the user 24 by the user clicking on an appropriate control (e.g., a button stating “E-Mail”) provided by the Web property 30. A separate control of the Web property 30 (see FIG. 1) may also be provided to provide a plurality of information at once (e.g., e-mail, postal address, phone number). Furthermore, the sponsor site may also provide the user 24 with an option to be contacted at sometime in the future. These and other options are preferably available to the user via the sponsor's site, and such availability is preferably dependent upon arrangements with the KAP 36.

The data selected by the user 24 is compiled by the interactive online research system 20 (step 107) and is sent to the keyword auction provider 36 (step 108) for use by the sponsor, or to the sponsor directly. Preferably, the user's response data along with that of other users is also stored within the database 34 of the interactive online research system 20 (step 110) and is collectively analyzed for optimization of future survey questions and answers.

Upon completion of visiting (using) the presented Web site or document, the user 24 preferably has the option to close the site (for example, via a suitable control widget), whereby the user is returned to the Web property 30. At this point, the interactive online research system 20 may provide additional survey questions to the user 24 via the Web property 30. In a preferred embodiment, if the user 24 wishes to temporarily close a particular interactive session, he or she may submit a request (again, via a suitable control widget) to have the interactive online research system 20 (preferably through the database 34) collect a list of Web sites or documents retrieved during the session and display them at a future time, either during the present interactive session, or at a later session. The user 24 preferably also may select a function to create a new browser window, for example, to be redirected to a sponsor's Web site.

Preferably, each answer (and question) is tracked within the database 34 to prevent duplicate questions upon repeat visits to the Web property 30 by the user 24. Every AID selected where a redirect to a sponsor's site exists preferably is tracked inclusive of user information (such as demographic information), and/or cost information for a sponsored link. However, it is not necessary that every answer identifier have a search engine redirect, and thus tracking for these answers may or may not occur.

According to a preferred embodiment, with the user's explicit permission, all or part of the stored data may also be sold offline to varying entities. The collected data, with the user's permission, may also be used for consumer profiling, customer acquisition, direct mail, telemarketing, and e-mail marketing, for example. A user 24 may also select that he or she wishes to receive email related to the interactive online research system 20 and/or sponsors.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. A method of locating an online site, comprising:
providing a question associated with a plurality of predefined answers;
receiving one of the plurality of predefined answers, the one of the plurality of predefined answers being associated with a keyword;
retrieving a link for the online site, the online site being associated with the keyword.

2. The method of claim 1 wherein the step of providing comprises:
retrieving a survey page, the page including the question;
presenting the survey page to a user within a Web property.

3. The method of claim 2 wherein the question, the plurality of predefined answers, the keyword and the link are stored within a database.

4. The method of claim 1 wherein the link is a uniform resource locator (URL).

5. The method of claim 5 wherein the question is stored according to a question profile, and wherein each of the plurality of predefined answers is stored according to an answer profile.

6. The method of claim 3 wherein the link is associated with the keyword within the database.

7. The method of claim 3 wherein the database is connected to a server hosting a Web property.

8. The method of claim 7 wherein the database is connected to a server hosting a Web portal.

9. The method of claim 8 wherein the user and the Web portal are connected via the Internet.

10. The method of claim 2 further comprising the step of:
displaying the link in a window of the Web property.

11. The method of claim 1 further comprising the step of:
redirecting the user to the online site via the link.

12. The method of claim 11 wherein the step of redirecting the user to the online site further comprises displaying the online site in a window of the Web property.

13. The method of claim 3 wherein the step of retrieving a link comprises:
querying the database to determine if the selected one of the plurality of answers is associated with the link;
retrieving the link from the database.

14. The method of claim 3 wherein the keyword is provided to the database by a keyword auction provider.

15. The method of claim 3 wherein the keyword is provided to the database by a sponsor.

16. The method of claim 3 wherein the question is directed to at least one of demographic information of the user and an interest of the user.

17. The method of claim 1 wherein the step of retrieving a link comprises the steps of:
retrieving a plurality of links;
selecting at least one of the plurality of links.

18. The method of claim 1 wherein the step of selecting at least one of the plurality of links comprises:
determining an order of preference from among the plurality of links;
retrieving the link, wherein the link is highest in the order of preference.

19. The method of claim 3 wherein the step of providing the question comprises the steps of:
determining a rating associated with the question and the predefined answers;
analyzing a plurality of questions stored in the database;
selecting one of the plurality of questions based on the determined rating.

20. The method of claim 19 wherein the step of determining a rating comprises the step of:
determining a first value related to remuneration related to keywords associated with the question and the predefined answers.

21. The method of claim 19 wherein the step of determining a rating further comprises the step of:
determining a second value related to appeal of the user as to the question.

22. The method of claim 21 wherein the rating is derived using the first value and the second value.

23. The method of claim 22 wherein the step of determining a rating further comprises the step of:
adding an additional value to the rating to weight the rating.

24. The method of claim 20 wherein the appeal of the user is based on at least one of demographic information supplied by the user and interest information supplied from the user.

25. The method of claim 24 wherein the demographic information supplied by the user is maintained in a profile within the database.

26. The method of claim 8 wherein the Web portal is contained within a window, and wherein the presented online set is displayed within the window.

27. The method of claim 26 wherein the presented online site is made at least partially opaque.

28. The method of claim 26 wherein the presented online site further includes a displayed control so the user can more clearly view the presented Web page.

29. The method of claim 26 further comprising:
presenting a plurality of additional links within the window, whereby selecting one of the additional links redirects the user to a second presented online site.

30. The method of claim 1 further comprising the step of:
presenting at least one additional question to the user based on the answer received to a previous question.

31. A method of locating an online site or document, the method comprising the steps of:
receiving at least one question;
submitting an answer to the at least one question, the answer having a predefined association with the online site or document;
displaying the online site or document.

32. The method of claim 31 wherein said step of receiving comprises:
displaying a page including the at least one question and a plurality of predetermined answers via a Web browser.

33. The method of claim 32 wherein said step of submitting an answer comprises:
selecting one of the plurality of predetermined answers by activating a control on the displayed page.

34. The method of claim 32 wherein said step of displaying the online site or document comprises displaying the online site or document within a frame of the page.

35. The method of claim 31 wherein the step of displaying the Web site comprises the steps of:
receiving a page displaying a link to the online site or document;
selecting the link to display the online site or document.

36. A method of providing an online site or document, the method comprising:
associating the online site or document with a predefined answer to a question, the question having a plurality of selectable answers including the predefined answer;
presenting the question;
receiving one of the plurality of selectable answers;
if the received one of the plurality of selectable answers is the predefined answer, retrieving the associated online site or document;
providing the retrieved associated online site or document.

37. The method of claim 36 wherein said step of associating associating the online site or document with a predefined answer comprises the step of:
associating at least one keyword with the predefined answer, the at least one keyword being associated with the online site or document.

38. The method of claim 37 wherein said step of associating at least one keyword with the predefined answer comprises the step of:
associating the at least one keyword to at least one root term, the root term being associated with the predefined answer.

39. The method of claim 37 wherein the association between the keyword and the online site or document is based on information from a keyword auction provider.

40. The method of claim 37 wherein the association between the keyword and the online site or document is based on information from a search engine.

41. The method of claim 39 wherein said step of providing the online site or document comprises the step of:
providing a link to the online site or document via a Web property.

42. The method of claim 37 wherein said step of presenting the question comprises displaying the question and the plurality of selectable answers within the Web property.

43. The method of claim 36 wherein the online site or document is at least one of a Web page and Web site.

44. The method of claim 37 wherein the predefined answer is associated with a plurality of documents including the online site or document, and wherein said step of retrieving the associated online site or document includes:
selecting the online site or document from among the plurality of documents.

45. The method of claim 44 wherein the step of selecting the online site or document is based at least partially on information provided by the keyword auction provider.

46. The method of claim 45 further comprising the steps of:
determining that the online site or document has been provided;
receiving remuneration directly or indirectly from the keyword auction provider.

47. A method of providing an online site or document, the method comprising:
associating one or more keywords with a predefined answer to a question, the question having a plurality of selectable answers including the predefined answer;
presenting the question;
receiving one of the plurality of selectable answers;
if the received one of the plurality of selectable answers is the predefined answer, using the associated one or more keywords to retrieve a link to the online site or document;
presenting at least one of the retrieved link and the online site or document.

48. A system for providing an online site or document comprising:
means for associating the online site or document with a predefined answer to a question, the question having a plurality of selectable answers including the predefined answer;
means for presenting the question to a user;
means for receiving one of the plurality of selectable answers from the user;
means for determining whether the received one of the plurality of selectable answers is the predefined answer;
means for retrieving the associated online site or document if the received one of the plurality of selectable answers is the predefined answer;
means for providing the retrieved associated online site or document to the user.

49. A program storage device readable by a machine, tangibly embodying a program of instructions executable by the machine to perform method steps for providing an online site or document, said method steps comprising
associating the online site or document with a predefined answer to a question, the question having a plurality of selectable answers including the predefined answer;
presenting the question to a user;
receiving one of the plurality of selectable answers from the user;
determining whether the received one of the plurality of selectable answers is the predefined answer;
retrieving the associated online site or document if the received one of the plurality of selectable answers is the predefined answer;
providing the retrieved associated online site or document to the user.

50. An apparatus for providing an online site or document, the apparatus comprising:
a propagated signal that when executed causes a computer to perform the steps of:
associating the online site or document with a predefined answer to a question, the question having a plurality of selectable answers including the predefined answer;
presenting the question to a user;
receiving one of the plurality of selectable answers from the user;
determining whether the received one of the plurality of selectable answers is the predefined answer;
retrieving the associated online site or document if the received one of the plurality of selectable answers is the predefined answer;
providing the retrieved associated online site or document to the user.
